(19) United States
(12) Patent Application Publication
(10) Pub. No.: US 2004/0243969 A1
(43) Pub. Date: Dec. 2, 2004

(54) On line presentation software

(76) Inventors: Brian Clinton Kamery, Pearland, TX (US); Ovais Reza, Austin, TX (US)

Correspondence Address: Woodard, Emhardt, Naughton,, Moriarty and McNett LLP, Bank One Center/Tower, 111 Monument Circle, Suite 3700, Indianapolis, IN, 46204-5137, US

(21) Appl. No.: 10/321,737

(22) Filed: Dec. 16, 2002

Related U.S. Application Data
(60) Provisional application No. 60/341,358, filed on Dec. 14, 2001.

(51) Int. Cl. G06F 9/44

(52) U.S. Cl. 717/101

(57) ABSTRACT

A computer system is disclosed that provides a presentation software application that is easily migrated across multiple computing platforms and operating systems. The software produces presentations that are scalable to conform to the user's display and are portable between computers independent of the computer's operating systems. Presentations may be made interactive by allowing a user to edit a presentation while that presentation is being presented by a second user.

### REFERENCE TO RELATED APPLICATIONS

This application claims priority from a Provisional Application Ser. No. 60/341,358, filed Dec. 14, 2001, which is hereby incorporated by reference.

### BACKGROUND OF THE INVENTION

The present invention relates to internet-based computing and, more particularly, to a presentation software application that permits easy transmission over the internet.

Presentation software is the second most used office application after word processing. Although many presentations are shown to a captive audience at a single location, the cost and difficulty of travel is increasing the need for transportable presentations that may be sent to a variety of individuals operating on a variety of computing platforms.

Existing presentation software does not provide the level of portability that is needed. Microsoft®) PowerPoint™ is the most popular presentation graphics software application in use today, but PowerPoint is limited to use on computers using the Microsoft Windows™ family of operating systems. Additionally, PowerPoint presentations are not easily transferred via the internet as users must export the presentation to an internet-based format, such as HTML or XML, prior to uploading the presentation to a web server. Additionally, supporting media elements, such as sound clips or images, are required to be exported as separate files, which can result in the presentation comprising a large number of files that must be transferred. There is therefore a need for a presentation graphics software application that operates over multiple computing platforms as well as permits simple and efficient transfer of presentations over the internet.

### SUMMARY OF THE INVENTION

It is therefore an object of the present invention to provide a presentation graphics software application that seamlessly operates over multiple operating systems and computing platforms.

It is a further object of the invention to provide a presentation graphics software application that allows simple transportability of presentations over the internet.

It is a further object of the invention to provide a presentation graphics software application that requires only a basic level of computer skills.

These and other objects will become apparent from the illustrated drawing and the description of the embodiments.

### BRIEF DESCRIPTION OF THE DRAWING

FIG. 1 is a block diagram of a computer communications network in accordance the present invention.

### DESCRIPTION OF THE EMBODIMENTS

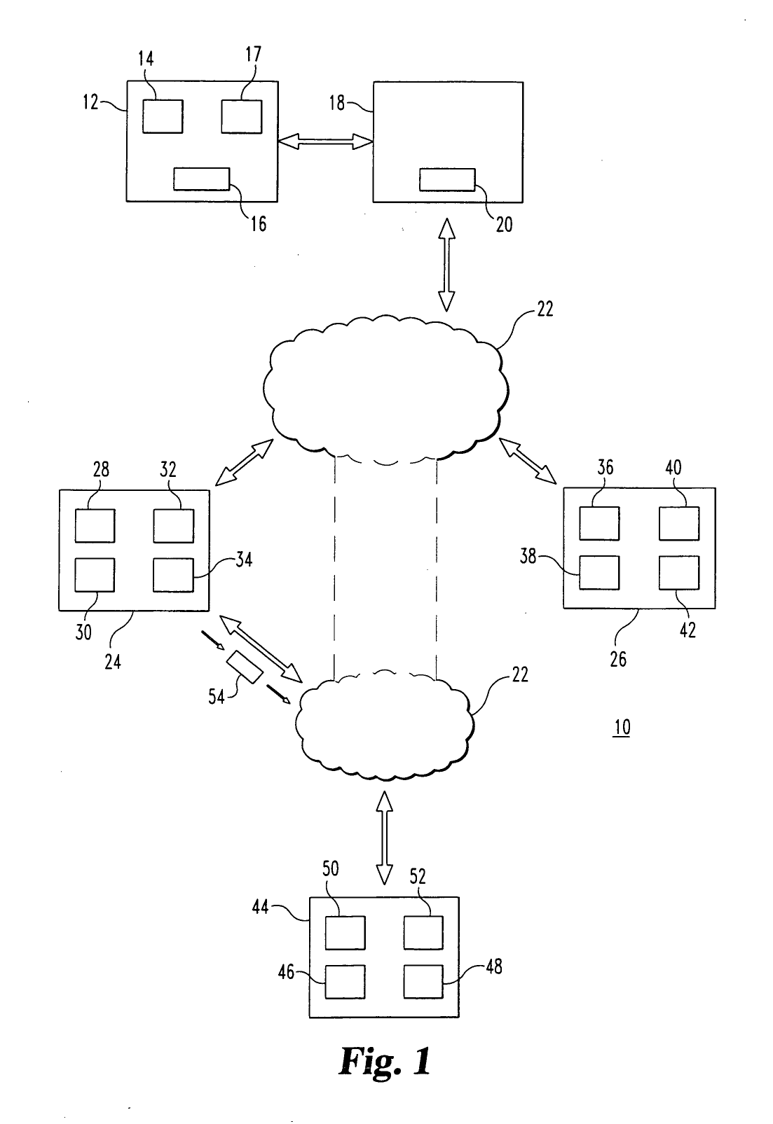

Referring to FIG. 1, there is shown a remote server-based computer system 10 that includes a central server 12. Server 12 may be of conventional design and is shown as including a processor 14, memory 16, and the server-side portion of the presentation graphics application of the present invention, designated as element 17. Server 12 is operatively connected with computer 18, which forms a connection machine with individual users on the system network. Computer 18 incorporates security functionality, including firewall 20. Individual users are operably connected to computer 18, and hence server 12, through a connection via the internet, designated as element 22 in FIG. 1. The number of individual users on system 10 at any given time may vary considerably, and may be quite large, but for illustration purposes, FIG. 1 shows individual users as represented by computers 24 and 26. Computers 24 and 26 may use the same operating system, or they may use different operating systems or computing platforms. Computer 24 is illustratively shown as including a processor 28, memory 30 and internet communications functionality 32, which may take a variety of forms, including a telephonic modem or a cable modem, for example. Computer 24 also includes the client-side functionality of the presentation software application of the present invention, designated in FIG. 1 as element 34. Similarly, computer 26 includes a processor 36, memory 38 and communications functionality 40. The client-side functionality of the presentation software application of the present invention is shown as part of computer 26 and designated as element 42.

Server 12 and computer 18 operate to allow individual users, via computers 24 and 26, for example, to use server 12 as a network server on which various software applications are stored. These applications may include word processing and spread sheet analysis programs, for example, and the presentation graphics application of the present invention. Users of computers 24 and 26 may establish operative connection with server 12 via firewall 20 through an internet connection 22. Documents and other materials created by remote users, such as users identified with computers 24 and 26, may also be stored on server 12 in a secure manner that protects against data loss.

In accordance with a particular aspect of the present inventions, presentation software 34 and 42 of computers 24 and 26, respectively, have been developed using Java® 2D Graphics, Swing and Java Networking software architecture, which permits ready portability of prepared presentations across multiple computing platforms and operating systems. In much the same way that other known presentation graphics applications are used, enabled users can create, edit, save, open, and display presentations. Presentations may be stored on server 12, but they may also be stored locally by users on their own computers. For presentations that are stored on server 12, an authorization from the administrator of server 12, or an authorization by the creator or editor of a presentation, allows other users having access to server 12 to also have access to presentations stored on server 12. A user who creates or edits a presentation, such as user of computer 24, for example, may notify other users of server 12, such as the user of computer 26, for example, that a presentation has been made available for viewing and/or other functions such as editing. Computer 26 user may then, through its established connection with server 12, and with the operation of presentation software element 17, “share” (e.g., edit, view, etc.) the subject presentation created or edited by computer 24 user.

In accordance with another aspect of the present invention, users can also easily broadcast and transfer presentations to others, even if the recipients are not enabled to access server 12. A recipient not having access to server 12 is illustratively shown and identified as computer 44. Computer 44 is illustratively shown as comprising a processor 46, memory 48, and communications functionality 50. Also incorporated in computer 44 is the needed functionality 52 of the presentation graphics software of the present invention. The recipient designated by computer 44 will only require whatever portion 52 of the client-side software that is needed for the recipient's function. For example, if the recipient is only authorized, or desires, to view presentations, the functionality of software 52 may be so limited. For recipients who desire to create their own presentations, or edit presentations that are sent to them, creation and editing functionality is required of software 52.

FIG. 1 illustrates, as an example, the transfer of a presentation 54 from computer 24 to the user of computer 44 by way of a connection via internet 22, which may be a simple email link, for example. If desired, the installed and authorized functionality of the users of computer 24 and/or computer 44 may allow interactive presentations. This functionality allows one or more users the capability to edit a presentation, or provide comments, while the presentation is being shown and managed by the presenter, which is tantamount to presenting a live presentation to all users at one time in one location. Users may interact with the presenter via audio, video, instant messaging, or a whiteboard, as examples, depending upon the functionality allowed by the presenter.

In accordance with yet another aspect of the present invention, the presentation software is based on Scalable Vector Graphics (SVG) technology. SVG is an industry standard format. The standard documents for SVG 1.0, which are publicly available, are incorporated herein by reference. The use of SVG results in a number of advantages, including the fact that the user interface and navigation of the software will therefore be standard across all computing platforms and operating systems; animated text and graphics, including animated charts, graphs and tables, are readily available for incorporation into presentations A large library of special effects, as well as audio and video snippets, images and clipart, is also available. SVG technology also provides for accurate and appropriate scaling for any sized display that is being used by the recipient of the presentation.

As previously described, a desirable advantage of the presentation software of the present invention is the ability to store and transfer presentations as ordinary files. Presentation files may be stored on server 12, with server 12 being treated as a network server that provides data backup and disaster recovery capability, or they may be stored locally on the user's computer hard drive. Presentation files may also be posted on a presenter's web site with a web link being provided to permit access to the presentation. Access to, and the ability to create, edit, view, and broadcast presentation files is determined by whether the user has the necessary enabling software and is authorized to perform such functions by the presenter. Such software can be provided by authorized download to the user's computer system, for example.

While the present invention has been illustrated in the drawing and described in detail in the foregoing description, it is understood that such illustration and description are illustrative in nature and are not to be considered restrictive, it being understood that only the preferred embodiments have been shown and described and that all changes and modifications that would be apparent or would occur to one skilled in the art are to be protected.

1. Software for managing a presentation, wherein:
the resolution of said presentation is adjusted such that said presentation is visually scalable to provide a full screen image over a range of display sizes;
said presentation is transportable between a first computer having a first operating system and a second computer having a second operating system; and
said presentation is transparent to the compatibility of said first and second operating system.

2. The software described in claim 1, wherein said presentation is transportable over the internet.

3. The software described in claim 1, wherein said presentation may be posted to a website for access by said first and second computers.

4. The software described in claim 1, wherein said presentation is transportable via electronic mail.

5. The software described in claim 1, wherein said presentation is located on a remote server that provides access to a plurality of users.

6. The software described in claim 1, wherein said presentation is developed using Java-based computing architecture.

7. The software described in claim 1, wherein said presentation may be managed by said second computer while under the control of said first computer, thereby resulting in the nature of an interactive presentation.

8. Software for managing a presentation, wherein:
said presentation is accessible from a first computer having a first operating system by a plurality of remote computers, wherein at least one of said plurality of computers has an operating system incompatible with said first operating system, and wherein the functionality of said presentation is independent of the compatibility of said first operating system and said incompatible operating system, and wherein said first computer controls the degree of functionality permitted by individual ones of said plurality of computers with respect to said presentation.

9. The software described in claim 8, wherein said functionality comprises one or more of creation, editing, viewing, transferring, broadcasting, or storing.

10. A system for managing a presentation comprising:
a first computer incorporating storage means in which a presentation is stored;
a second computer;
communications means associated with said first computer and said second computer for providing access to said presentation by said second computer; and
software associated with said first computer and said second computer for determining the degree of functionality permitted by said second computer with respect to said presentation.

11. The system of claim 10, wherein said functionality comprises at least one of creating, editing, viewing, transferring, broadcasting or storing.

12. A system for managing presentations comprising:
a first computer adapted for maintaining a presentation;
a plurality of second computers;
communications means associated with said first computer and said plurality of second computers for providing access to said presentation by said second computers; and
software associated with said first computer and said plurality of second computers for independently determining the degree of functionality permitted by each of said second computers with respect to said presentation.

13. The system of claim 12, wherein said functionality comprises at least one of creating, editing, viewing, transferring, broadcasting or storing.

14. The system of claim 12, wherein said software permits access to said functionality of said presentation by way of communication between two or more of said plurality of second computers independent of said first computer, said access being limited to said determined level of functionality associated with each of said two or more computers.

15. A method for managing a presentation comprising the steps of:
storing a presentation on a first computer;
providing communication means for allowing access to said presentation by a second computer; and
providing means associated with said first computer and said second computer for controlling the nature of said presentation by determining the degree of functionality permitted by said second computer with respect to said presentation.

16. The method of claim 15, wherein said determining said degree of functionality comprises controlling at least one of creating, editing, viewing, transferring, broadcasting or storing of said presentation by said second computer.

17. A method for managing presentations comprising the steps of:
maintaining a presentation associated with a first computer;
providing access to said presentation by a plurality of second computers; and
independently determining by said first computer the degree of functionality permitted by each of said second computers with respect to said presentation.

18. The method of claim 17, wherein said functionality of each of creating, editing, viewing, transferring, broadcasting and storing is independently determined for each of said plurality of second computers.

19. A method for managing a presentation comprising the steps of:
associating a presentation with a first computer;
providing communication means for allowing access to said presentation by a plurality of second computers; and
providing means associated with said first computer and said plurality of second computer for enabling at least one of said plurality of second computers to functionally interact with said first computer in response to accessing said presentation such that said interaction is apparent to at least an additional one of said plurality of second computers.

20. The method of claim 19, wherein said interaction is apparent to each one of said second computers.
